(19) United States
(12) Patent Application Publication
(10) Pub. No.: US 2009/0109465 A1
(43) Pub. Date: Apr. 30, 2009

(54) CONTROLLING PAGE SCANS

(75) Inventor: Asif Grushkevich, La Jolla, CA (US)

Correspondence Address: BRAKE HUGHES BELLERMANN LLP;c/o CPA Global, P.O. Box 52050, Minneapolis, MN, 55402, US

(73) Assignee: BROADCOM CORPORATION, Irvine, CA (US)

(21) Appl. No.: 11/929,369

(22) Filed: Oct. 30, 2007

(51) Int. Cl. G06F 15/00

(52) U.S. Cl. 358/1.15

(57) ABSTRACT

A system may include a tracking module that is arranged and configured to track usage of a device, a command module that is arranged and configured to generate a command to control page scans, where the command to control the page scans is based on the usage of the device, and an execution module that is arranged and configured to receive the command to control the page scans and to execute the command to control the page scans.

### TECHNICAL FIELD

This description relates to controlling page scans.

### BACKGROUND

One device may communicate with another device using a communication protocol. The communication protocol may include a procedure for the two devices to establish a connection. For example, two Bluetooth®-enabled devices, such as a cell phone and an ear piece, may communicate with one another using the Bluetooth protocol. The Bluetooth protocol may include a procedure for the two devices to establish the connection.

### SUMMARY

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary block diagram of a system for controlling page scans.

FIG. 2 is an exemplary block diagram of an exemplary implementation of the system of FIG. 1.

FIG. 3A is an exemplary block diagram of an exemplary implementation of the system of FIG. 1.

FIG. 3B is an exemplary block diagram of an exemplary implementation of the system of FIG. 1.

FIG. 4A is an exemplary time graph of a period of page scans.

FIG. 4B is an exemplary time graph of a period of page scans.

FIG. 4C is an exemplary time graph of a period of page scans.

FIG. 5 is an exemplary flowchart illustrating example operations of the system of FIG. 1.

### DETAILED DESCRIPTION

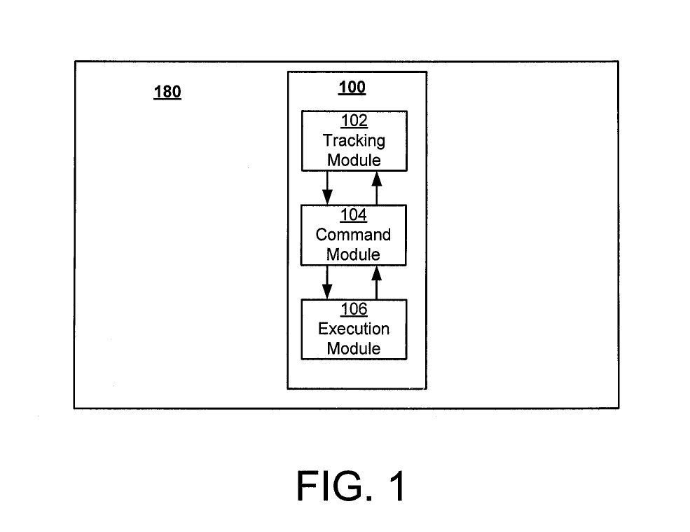

Referring to FIG. 1, a system 100 may include a tracking module 102, a command module 104 and an execution module 106. In general, system 100 may be used to control page scans based on the usage of a device 180 and/or a time of day. The tracking module 102 may be arranged and configured to track usage of the device 180. The command module 104 may be arranged and configured to generate a command to control the page scans, where the command to control the page scans is based on the usage of the device and/or based on the time of the day. The execution module 106 may be arranged and configured to receive the command to control the page scans and to execute the command to control the page scans.

A page scan may include any procedure that a device may use as part of a connection procedure to connect to another device as part of a communication protocol. Page scans may be used in any type of communication protocol and are not limited to any specific type of communication protocol. When a device uses page scans, the page scans may use the power resources of the device for this process. By controlling the page scans, the power consumption of the device may be conserved. Controlling the page scans may save the power of the device and provide for longer operating and/or standby times for the device. For example, controlling the page scans may include modifying the time between page scans (e.g., the page scan interval) such as by increasing the time between page scans and/or disabling the page scans during periods of device inactivity.

In one exemplary implementation, the Bluetooth protocol may be used by two devices to communicate with one another. One device (e.g., a master device) may page another device (e.g., a slave device) and the other device may use page scans to listen for the pages. In this example implementation, the page scans may include a procedure where a device listens for pages received on a communication channel of the device. The communication channel may be designated for these particular type of communications. The connection procedure may proceed to establish a connection when the slave device receives the page during a page scan and responds to the master device with a response. The slave device may save on power consumption by controlling the page scans such that unnecessary page scans are not being performed.

In one exemplary implementation, the system 100 may be arranged and configured to operate in many different types of devices 180. For example, system 100 may be arranged and configured to operate in a cellular phone, a smart phone, an MP3 player, an iPod® player, a personal digital assistant (PDA), a mobile handset, other types of devices, and/or in devices that include a combination of these types of devices. These one or more devices 180 may be arranged and configured to communicate with other devices using a communication protocol. For example, these devices 180 may use a Bluetooth protocol to communicate with one another.

In one exemplary implementation, the system 100 may be arranged and configured to be implemented as an integrated circuit. The integrated circuit may be arranged and configured to operate in many different types of devices 180. For example, system 100 may be arranged and configured to operate in a cellular phone, a smart phone, an MP3 player, an iPod® player, a personal digital assistant (PDA), a mobile handset, other types of devices, and/or devices that include any combination of these types of devices. The integrated circuit may be arranged and configured to be implemented as a single chip solution that operates in the different types of applications described above. The components of system 100 may be implemented on one or more integrated circuits and in some instances, one or more components may be implemented on one integrated circuit and the remaining components may be implemented on a different integrated circuit, with the two integrated circuits capable of communicating with each other.

The tracking module 102 may be arranged and configured to track usage of the device 180. The tracking module 102 may track the time of when the device 180 is in use including the start and stop times of the device 180. By keeping track of this information, the tracking module may determine and track periods of inactivity for the device 180 and periods of use for the device 180. The tracking module 102 also may determine when the device 180 is in use or when a user starts using the device 180 again after a period of inactivity such as when a user interacts with a user interface on the device 180 or such as when the device 180 receives an incoming signal from another device. The incoming signal from another device may be a signal other than a request to establish a connection with the device 180.

Additionally and/or alternatively, the tracking module 102 may be arranged and configured to track a time of day. The tracking module 102 may include a clocking function or may access a clocking function from another section of the device 180. The tracking module 102 may be configurable to adjust for different time zones and for daylight savings time so that the time of day may accurately be tracked for the specific geographic location of the device 180.

The information from the tracking module 102 may be used by the command module 104 to generate a command to control the page scans, where the command to control the page scans is based on the usage of the device 180. Additionally and/or alternatively, the command to control the page scans may be based on the time of day.

The execution module 106 may be arranged and configured to receive the command from the command module 104 and to execute the command. The execution of the command may cause the device 180 to follow the instructions of the command. The instructions of the command may include different types of instructions including, for example, disabling the page scans, enabling the page scans, modifying a period of time between the page scans (e.g., modifying the page scan interval), enabling the page scans using a default period of time between the page scans, enabling the page scans using a modified period of time between the page scans, other instructions, and any combinations of these instructions.

In one exemplary implementation, the tracking module 102 may determine that the device 180 may be inactive for a period of time. The command module 104 may generate a command to modify the period of time between page scans based on the inactivity of the device 180. For instance, the command module 104 may generate a command that increases the time between page scans. The execution module 106 may receive and execute the command to modify the period of time between the page scans. In this manner, the device 180 may save power because the power is not being wasted on page scans that otherwise may occur more frequently during periods of inactivity for the device 180. The period of inactivity of the device 180 may be a configurable period such that a user and/or a manufacturer of the device 180 can set the period of inactivity after which the command to modify the page scans would be generated.

In some instances, the period of inactivity of a device 180 may include when the device 180 enters a particular mode. For instance, a period of inactivity may include when the device 180 enters a sleep mode, a hibernate mode, or some other type of passive or inactive type of mode.

In another exemplary implementation, the tracking module 102 may determine that the device 180 may be inactive for a period of time. The command module 104 may generate a command to disable the page scans. The execution module 106 may receive and execute the command to disable the page scans. In this manner, the device 180 may save power because the power is not being wasted on page scans that otherwise may occur continuously during periods of inactivity for the device 180. The period of inactivity of the device 180 may be a configurable period such that a user and/or a manufacturer of the device 180 can set the period of inactivity after which the command to disable the page scans would be generated.

In another exemplary implementation, the tracking module 102 may be arranged and configured to track the time of day. The command module 104 may generate a command to control the page scans based on the time of day. The execution module 106 may receive and execute the command to control the page scans based on the time of day. For example, the command module 104 may be configured to generate a command to disable the page scans during the time of day when the device 180 is not likely to be in use. This time of day may be configurable by the user. Additionally and/or alternatively, the time of day to disable the page scans may be determined and set by the tracking module 102 after tracking one or more usage patterns of the device 180. For instance, the command module may generate the command to disable the page scans between the hours of 11:00 o'clock at night and 5:00 o'clock in the morning, when the device 180 may not likely to be in use. In this manner, the device 180 may save power because the power is not being wasted on page scans that otherwise may occur continuously during periods of inactivity for the device 180.

The command module 104 may be configured to generate a command to enable the page scans based on the time of day. For instance, the command module may generate the command to enable the page scans at 5:00 o'clock in the morning, when the device 180 may be likely to start being used. These times may be configurable to be set by a user and/or may be determined by the tracking module 102 based one or more usage patterns of the device 180.

In another exemplary implementation, the tracking module 102 may determine that the usage of the device 180 includes a use of the device 180. The command module 104 may generate a command to enable the page scans. The execution module 106 may receive and execute the command to enable the page scans. For example, the device 180 may be in a state where the page scans have been disabled due to a period of inactivity in order to save power for the device 180. A use of the device 180 may occur such as by, for example, a user interacting with a user interface of the device 180 and/or by receiving an incoming signal. The user interacting with the user interface and/or the device receiving an incoming signal are examples of triggers recognized by the tracking module 102, which may cause the command module 104 to generate the command to enable the page scans. Other types of triggers are possible. In this manner, when the device 180 is being used, it may be desirable to enable the page scans to allow the device 180 an opportunity to establish a link with another device using the page scans.

In another example, the device 180 may be in a state where the period between the page scans has been increased due to a period of inactivity in order to save power for the device 180. A use of the device 180 by the user may trigger the command module 104 to generate the command to enable the page scans at an increased frequency and/or at a default period between the page scans.

The command generated by the command module 104 to enable the page scans may include a command to enable the page scans using a default period of time between the page scans. The default period of time between the page scans may be configurable by a user and/or a manufacturer. Additionally and/or alternatively, the command generated by the command module 104 to enable the page scans may include a command to enable the page scans using a modified period of time between the page scans. For example, the modified period of time between the page scans may include a period of time that is longer than the default period of time. The modified period of time between the page scans may include a period of time that is shorter than the default period of time.

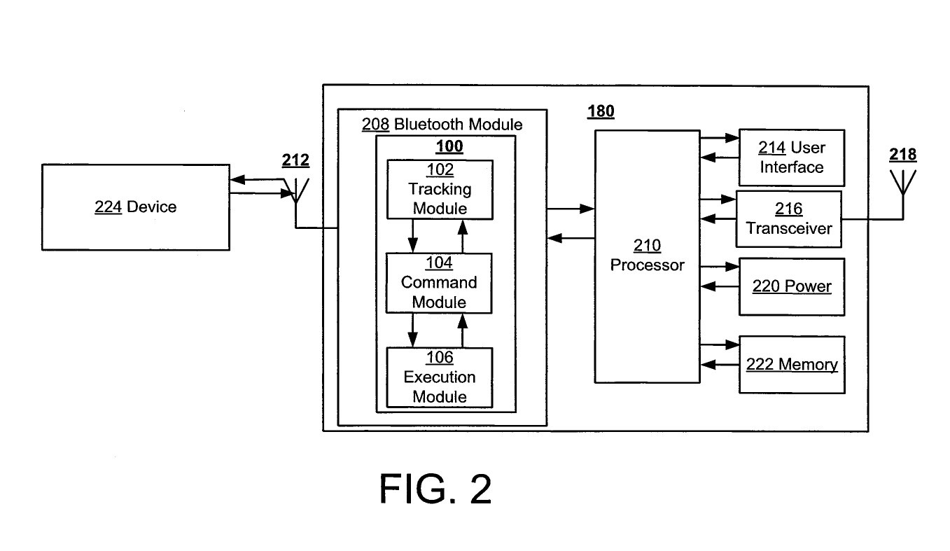

Referring also to FIG. 2, system 100 may be included with a Bluetooth module 208 having an antenna 212. The Bluetooth module 208 may be included as a component of the device 180. Device 180 also may include a processor 210, a user interface 214, a transceiver 216 having an antenna 218, a power module 220 and a memory module 222. Device 180 may be arranged and configured to communicate with device 224 using one or more communication protocols including, for example, the Bluetooth protocol. Device 180 may include the types of device discussed above with respect to FIG. 1 including any type of Bluetooth-enabled device. Device 224 also may include the same types of devices discussed above with respect to FIG. 1 including any Bluetooth-enabled device.

The Bluetooth module 208 may include system 100 as well as other Bluetooth-related components (not shown) for the operation of the Bluetooth functionality. The Bluetooth module 208 may enable the device 180 to communicate with device 224 and other Bluetooth-enabled devices using the Bluetooth protocol through antenna 212. System 100 and its components include the functionality and features described above with respect to FIG. 1.

The processor 210 may be arranged and configured to control the functioning and overall operation of the device 180, including the other components of the device 180. The processor 210 may include application specific firmware, operating instructions, and/or other software to control the operation of the device 180.

The user interface 214 may be arranged and configured to accept input from a user and to convey information to a user through a display or otherwise. As described above with respect to FIG. 1, the tracking module 102 may track the use of the device 180 based on a user's interaction with the user interface 214. In a Bluetooth-enabled cellular phone, for example, the user interface may include keys, buttons, a touch screen, a stylus for use with a screen, and/or other input interfaces. Interaction with the user interface may include opening a flip lid to the cellular phone or otherwise activating the cellular phone. If the tracking module 102 detects the use of the user interface 214 or other interaction with the user interface (e.g., opening the flip lid to the cellular phone), then the command module 104 may generate a command to control the page scans. For example, the command module 104 may generate a command to enable the page scans based on the interaction with the user interface 214, as described above with respect to FIG. 1.

The transceiver 216 may be arranged and configured to communicate with other devices through antenna 218 using one or more communication protocols. For example, the transceiver 216 may include a cellular transceiver that is arranged and configured to communicate cellular messages with other devices. Additionally and/or alternatively, the transceiver 216 may include a frequency modulation (FM) transceiver that may be arranged and configured to transmit and receive messages using frequency modulation.

The power module 220 may be arranged and configured to provide power to the device 180 and its components. The power module 220 may include a source of power such as, for example, one or more batteries. Controlling the page scans, for example, by disabling the page scans during periods of inactivity, by increasing the period of time between page scans during periods of inactivity, or by disabling the page scans during times of the day when the device 180 is not likely to be in use may conserve the power in the power module 220. Conserving the power of the power module 220 may increase the operating times and/or standby times of the device 180.

The memory module 222 may be arranged and configured to store information to be used by other components of the device 180. For example, the memory module 222 may store information collected by the tracking module 102 relating to the usage of the device 180. The memory module also may store any type of configuration information, including any configurable settings, relating to system 100.

In this exemplary implementation of system 100 as illustrated in FIG. 2, the device 180 may function as a master device and/or as a slave device with respect to the Bluetooth protocol. Likewise, if device 224 is a Bluetooth-enabled device, then device 224 may function as a master device and/or as a slave device with respect to the Bluetooth protocol.

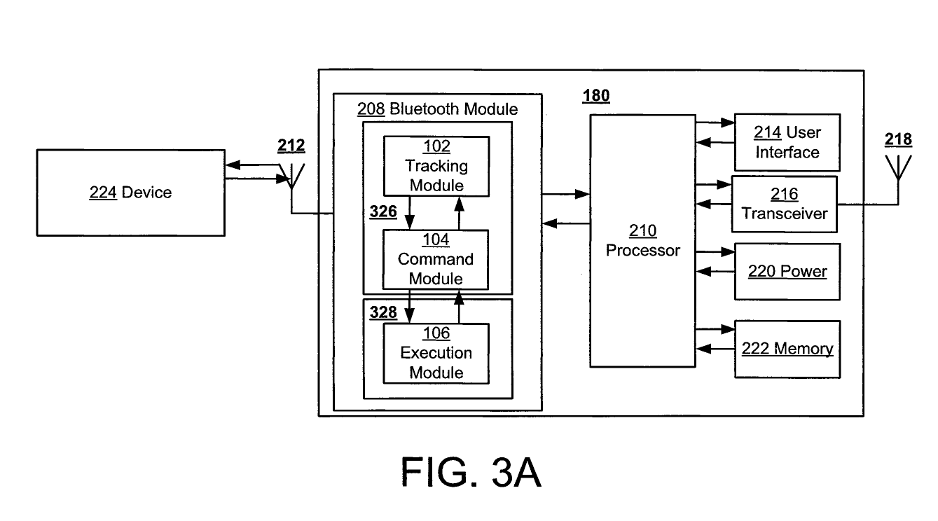

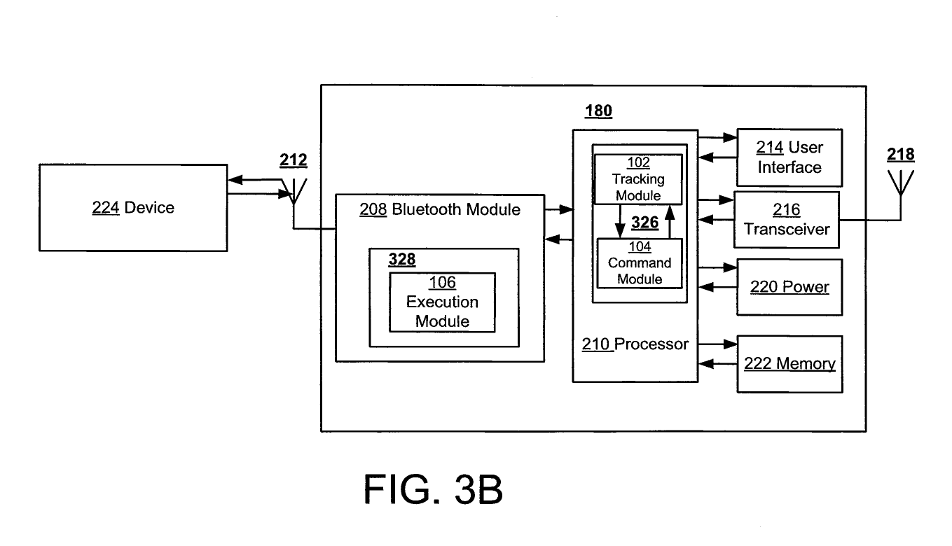

Referring to FIG. 3A, the Bluetooth module 208 may include an upper stack 326 and a lower stack 328. In one exemplary implementation, the upper stack 326 may include the tracking module 102 and the command module 104 and the lower stack 328 may include the execution module 106. In other exemplary implementations, the upper stack 326 may be referred to as a host and the lower stack 328 may be referred to as a controller. In other exemplary implementations, the command module 104 and the execution module 106 may be grouped together in the upper stack 326 or the lower stack 328. In the example of FIG. 3A, both the upper stack 326 and the lower stack 328 are a part of the Bluetooth module 208.

The upper stack 326 and/or the lower stack 328 may include additional Bluetooth-related components (not shown) including, for example, a channel manager, a logical link control and adaption protocol (L2CAP) resource manager, a device manager, a link manager, a baseband resource manager, a link controller, and/or a radio frequency block.

Referring to FIG. 3B, in another exemplary implementation, the processor 210 may include the upper stack 326, where the upper stack 326 may include the tracking module 102 and the command module 104. The Bluetooth module 328 may include the lower stack 328, where the lower stack 328 may include the execution module 106. Although FIG. 3B illustrates the upper stack 326 as including the tracking module 102 and the command module 104 and the lower stack 328 as including the execution module 106, these modules may be arranged in different combinations as part of the upper stack 326 and the lower stack 328.

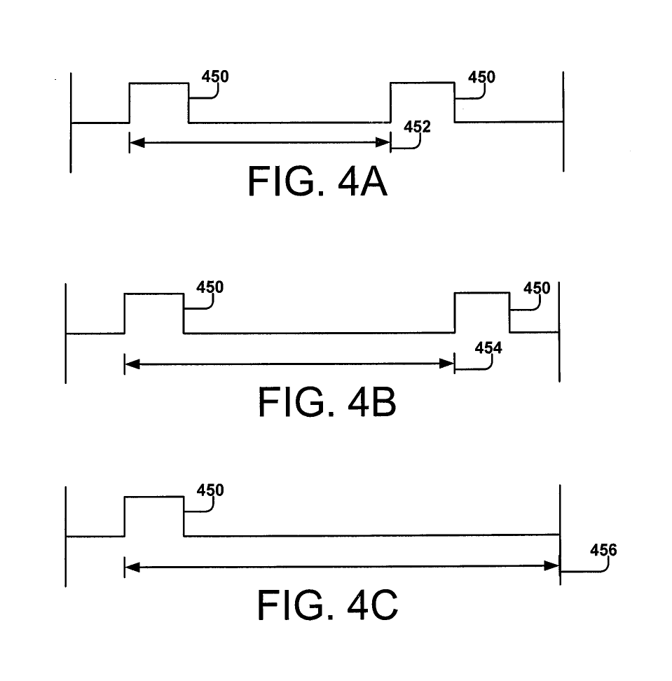

Referring to FIGS. 4A, 4B, and 4C, various illustrations are provided to show different periods of time between page scans. For example, in FIG. 4A, two page scans 450 are illustrated with a period 452 between the page scans. In this example, the period 452 between the page scans 450 may be a default period between the page scans.

Referring to FIG. 4B, the period 454 between the page scans 450 may represent a modified period between the page scans when compared to the period 452 of FIG. 4A. In this example, the command module 104 may have generated a command to modify the period 454 between the page scans based on the usage of the device, such as inactivity of the device. Thus, the period 454 between the page scans 450 may be increased when compared to a default period 452 between the page scans.

Referring to FIG. 4C, the period 456 between the page scans 450 has been disabled. In this example, the command module 104 may have generated a command to disable the page scans 450 based on the usage of the device, such as a period of inactivity, or based on a time of the day, such as in the middle of the night. Upon a subsequent use of the device, the command module 104 may generate a command to enable the page scans 450. For example, the command module 104 may generate a command to enable the page scans 450 using a default period 452 between the page scans 450, as illustrated in FIG. 4A.

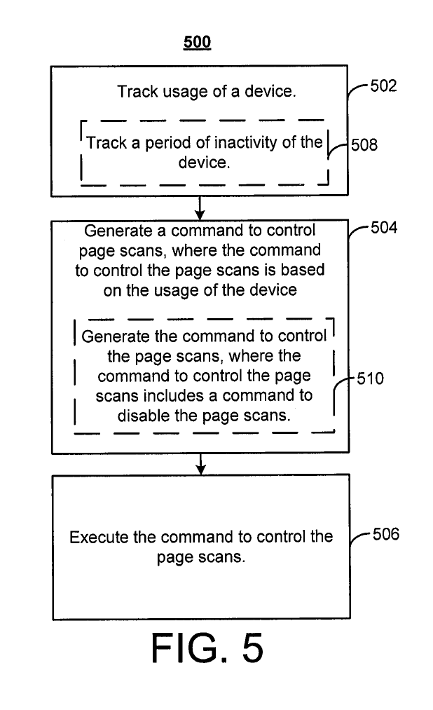

Referring to FIG. 5, a process 500 is illustrated for controlling the page scans. Process 500 may include tracking usage of a device (502), generating a command to control page scans, where the command to control the page scans is based on the usage of the device (504), and executing the command to control the page scans (506). Tracking the usage of the device (502) may include tracking a period of inactivity of the device (508). Generating the command to control the page scans (504) may include generating the command to control the page scans, where the command to control the page scans includes a command to disable the page scans (510).

In one exemplary implementation, the tracking module 102 of FIGS. 1, 2 and 3 may track the usage of a device (502), such as device 180. The tracking module 102 also may track a period of inactivity of the device (508). The command module 104 may generate the command to control the page scans (504) including the exemplary implementation where the command includes a command to disable the page scans (510). The execution module 106 may execute the command to control the page scans (506).

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system, comprising:
a tracking module that is arranged and configured to track usage of a device;
a command module that is arranged and configured to generate a command to control page scans, wherein the command to control the page scans is based on the usage of the device; and
an execution module that is arranged and configured to receive the command to control the page scans and to execute the command to control the page scans.

2. The system of claim 1 wherein:
the usage of the device includes a period of inactivity of the device, and
the command to control the page scans includes a command to modify a period of time between the page scans.

3. The system of claim 1 wherein:
the usage of the device includes a period of inactivity of the device, and
the command to control the page scans includes a command to disable the page scans.

4. The system of claim 1 wherein:
the usage of the device includes a use of the device, and
the command to control the page scans includes a command to enable the page scans.

5. The system of claim 1 wherein:
the usage of the device includes a use of the device, and
the command control the page scans includes a command to enable the page scans using a default period of time between the page scans.

6. The system of claim 1 wherein:
the usage of the device includes a use of the device, and
the command control the page scans includes a command to enable the page scans using a modified period of time between the page scans.

7. The system of claim 1 wherein:
the usage of the device includes a usage of a user interface on the device, and
the command to control the page scans includes a command to enable the page scans.

8. The system of claim 1 wherein:
the usage of the device includes receiving an incoming signal other than a page signal at the device, and
the command to control the page scans includes a command to enable the page scans.

9. The system of claim 1 wherein:
the usage of the device includes a use of the device following a period of inactivity, and
the command to control the page scans includes a command to enable the page scans.

10. The system of claim 1 wherein the device includes a Bluetooth-enabled device.

11. The system of claim 1 wherein the device includes a Bluetooth-enabled cellular phone.

12. A system, comprising:
a tracking module that is arranged and configured to track a time of day;
a command module that is arranged and configured to generate a command to control page scans, wherein the command to control the page scans is based on the time of the day; and
an execution module that is arranged and configured to receive the command to control the page scans and to execute the command to control the page scans.

13. The system of claim 12 wherein the command to control the page scans includes a command to disable the page scans based on the time of the day.

14. The system of claim 12 wherein:
the tracking module is arranged and configured to track usage of a device, and
the command to control the page scans is based on the usage of the device.

15. The system of claim 14 wherein the device includes a Bluetooth-enabled device.

16. The system of claim 12 wherein:
the tracking module is arranged and configured to track usage of a device,
the usage of the device includes a use of the device, and
the command to control the page scans is based on the usage of the device and includes a command to enable the page scans.

17. The system of claim 12 wherein:
the tracking module is arranged and configured to track usage of a device,
the usage of the device includes a usage of a user interface on the device, and
the command to control the page scans is based on the usage of the device and includes a command to enable the page scans.

18. The system of claim 12 wherein:
the tracking module is arranged and configured to track usage of a device,
the usage of the device includes receiving an incoming signal other than a page signal at the device, and
the command to control the page scans is based on the usage of the device and includes a command to enable the page scans.

19. A method for controlling page scans, the method comprising:
tracking usage of a device;
generating a command to control page scans, wherein the command to control the page scans is based on the usage of the device; and
executing the command to control the page scans.

20. The method as in claim 19 wherein:
tracking the usage of the device includes tracking a period of inactivity of the device, and
generating the command to control the page scans includes generating a command to control the page scans, wherein the command to control the page scans includes a command to disable the page scans.
